(19) United States
(12) Patent Application Publication
(10) Pub. No.: US 2026/0338986 A1
(43) Pub. Date: Oct. 29, 2026

(54) METHODS FOR IN-SITU CALIBRATION OF FLUID DISTRIBUTION AND WETTABILITY PARAMETERS FROM NMR RELAXATION MEASUREMENTS IN A NATURAL HYDROCARBON TRAPPING SYSTEM

(71) Applicant: Schlumberger Technology Corporation, Sugar Land, TX (US)

(72) Inventors: Saad Omar, Cambridge, MA (US); Chang-Yu Hou, Cambridge, MA (US); Lalitha Venkataramanan, Cambridge, MA (US)

(21) Appl. No.: 19/662,094

(22) Filed: Apr. 29, 2026

Related U.S. Application Data
(60) Provisional application No. 63/796,788, filed on Apr. 29, 2025.

(51) Int. Cl. G01V 3/32; E21B 49/00

(52) U.S. Cl. CPC G01V 3/32; E21B 49/00; E21B 2200/20; E21B 2200/22

(57) ABSTRACT

A method may include conveying an NMR-based logging tool to a fully-water saturated zone of a geological formation; receiving a first T₂ relaxation time to determine a fully-water saturated T₂ distribution; receiving a second T₂ relaxation time corresponding to a partially saturated water-wet zone; determining T_{c} and α based on the second T₂ relaxation time and the fully-water saturated T₂ distribution; modeling a predicted second T₂ relaxation time; refining the T_{c} and the α by comparing the second T₂ relaxation time and the predicted second T₂ relaxation time; receiving a third T₂ relaxation time corresponding to a mixed-wet zone; modeling a predicted third T₂ relaxation time; determining a water-wetting surface fraction (η_{w}) based on the third T₂ relaxation time, the predicted third T₂ relaxation time, the T_{c}, and the α; and performing a minimization procedure to refine the water-wetting surface fraction (η_{w}).

### CROSS-REFERENCE TO RELATED APPLICATION

This application is a Non-Provisional Patent Application claiming priority to U.S. Provisional Patent Application No. 63/796,788, entitled “METHODS FOR IN-SITU CALIBRATION OF FLUID DISTRIBUTION AND WETTABILITY PARAMETERS FROM NMR RELAXATION MEASUREMENTS IN A NATURAL HYDROCARBON TRAPPING SYSTEM,” filed on Apr. 29, 2025, which is hereby incorporated by reference in its entirety for all purposes.

### BACKGROUND

The present disclosure generally relates to systems and methods to increase efficiencies in determining various formation properties well logging tools. More specifically, the present disclosure relates to systems and methods for calibrating an NMR tool to determine the formation-specific parameters.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Producing hydrocarbons from a wellbore drilled into a geological region is a remarkably complex endeavor. In many cases, decisions involved in hydrocarbon exploration and production may be informed by measurements from downhole well-logging tools that are conveyed deep into the borehole. The measurements may be used to infer properties or characteristics of the geological region surrounding the borehole.

Nuclear magnetic resonance (NMR) tools may be used to collect such measurements. The measurements from an NMR tool (e.g., T₁ and T₂ distributions) may be indicative of the presence and characteristics (e.g., fluid distribution, fluid quantity, viscosity, etc.) of a hydrocarbon reservoir. For example, T₂ distributions collected during NMR logging operations may be useful in determining formation characteristics, such as wettability and fluid distribution, and formation-specific parameters, such as the water-wetting surface fraction η_{w}, the characteristic time that determines the inflection point in the T₂ space T_{c}, and the exponent, α, that controls the sharpness of the saturation transition around the characteristic time. However, determining these formation-specific parameters based upon the measurements made by the NMR tool has become increasingly complex.

To determine these formation-specific parameters more efficiently and accurately, it may be beneficial to calibrate the NMR petrophysical interpretations through an in-situ process.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method may include conveying a nuclear magnetic resonance (NMR)-based logging tool through a borehole to a fully-water saturated zone of a geological formation, receiving, from the NMR-based logging tool, first data indicative of a first transverse (T₂) relaxation time corresponding to the fully-water saturated zone to determine a fully-water saturated T₂ distribution, receiving, from the NMR-based logging tool, second data indicative of a second T₂ relaxation time corresponding to a partially saturated water-wet zone of the geological formation, determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution. Modeling a predicted second T₂ relaxation time based on the T_{c}, the α, and the fully-water saturated T₂ distribution, refining the T and the α based on a comparison of the second T₂ relaxation time and the predicted second T₂ relaxation time, receiving, from the NMR-based logging tool, third data indicative of a third T₂ relaxation time corresponding to a mixed-wet zone of the geological formation, modeling a predicted third T₂ relaxation time based on the T_{c}, the α, the fully-water saturated T₂ distribution, and a water saturation (S_{w}), determining a water-wetting surface fraction (η_{w}) corresponding to the mixed-wet zone based on the third T₂ relaxation time, the predicted third T₂ relaxation time, the T_{c}, and the α, and performing a minimization procedure to decrease a difference between the third T₂ relaxation time and the predicted third T₂ relaxation time to refine the water-wetting surface fraction (η_{w}).

In an embodiment, a system may include a nuclear magnetic resonance (NMR)-based logging tool configured to collect data indicative of a transverse (T₂) relaxation time within a borehole drilled into a geological formation, and a data processing system in communication with the NMR-based logging tool, wherein the data processing system is configured to perform operations including receiving, from the NMR-based logging tool, first data indicative of a first T₂ relaxation time corresponding to a fully-water saturated zone of the geological formation to determine a fully-water saturated T₂ distribution, receiving, from the NMR-based logging tool, second data indicative of a second T₂ relaxation time corresponding to a partially saturated water-wet zone of the geological formation, determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution, modeling a predicted second T₂ relaxation time based on the T_{c}, the α, and the fully-water saturated T₂ distribution, refining the T_{c} and the α based on a comparison of the second T₂ relaxation time and the predicted second T₂ relaxation time, receiving, from the NMR-based logging tool, third data indicative of a third T₂ relaxation time corresponding to a mixed-wet zone of the geological formation, modeling a predicted third T₂ relaxation time based on the T_{c}, the α, the fully-water saturated T₂ distribution, and a water saturation (S_{w}), determining a water-wetting surface fraction (η_{w}) corresponding to the mixed-wet zone based on the third T₂ relaxation time, the predicted third T₂ relaxation time, the T_{c}, and the α, and performing a minimization procedure to decrease a difference between the third T₂ relaxation time and the predicted third T₂ relaxation time to refine the water-wetting surface fraction (η_{w}).

In an embodiment, a tangible, non-transitory, computer-readable medium may include executable instructions that, when executed by processing circuitry, cause the processing circuitry to perform operations including receiving, from a nuclear magnetic resonance (NMR)-based logging tool, first data indicative of a first transverse (T₂) relaxation time corresponding to a fully-water saturated zone of a geological formation to determine a fully-water saturated T₂ distribution, receiving, from the NMR-based logging tool, second data indicative of a second T₂ relaxation time corresponding to a partially saturated water-wet zone of the geological formation, determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution, modeling a predicted second T₂ relaxation time based on the T_{c}, the α, and the fully-water saturated T₂ distribution, refining the T_{c} and the α based on a comparison of the second T₂ relaxation time and the predicted second T₂ relaxation time, receiving, from the NMR-based logging tool, third data indicative of a third T₂ relaxation time corresponding to a mixed-wet zone of the geological formation, modeling a predicted third T₂ relaxation time based on the T_{c}, the α, the fully-water saturated T₂ distribution, and a water saturation (S_{w}), determining a water-wetting surface fraction (η_{w}) corresponding to the mixed-wet zone of the geological formation based on the third T₂ relaxation time, the predicted third T₂ relaxation time, the T_{c}, and the α, and performing a minimization procedure to decrease a difference between the third T₂ relaxation time and the predicted third T₂ relaxation time to refine the water-wetting surface fraction (η_{w}).

The brief summary presented above is intended only to familiarize the reader with certain aspects and contexts of embodiments of the present disclosure without limitation to the claimed subject matter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 depicts an embodiment of a wellsite system for measuring borehole data using various downhole tools, in accordance with embodiments of the present disclosure;

FIG. 2 depicts an embodiment of a well control system and logging tool that may operate in conjunction with the wellsite system of FIG. 1 to perform natural resource operations, in accordance with embodiments of the present disclosure;

FIG. 3 depicts a simplified schematic view of an embodiment of an NMR-based downhole logging tool, in accordance with embodiments of the present disclosure;

FIG. 4 depicts a flowchart of an embodiment of a method for calibrating an NMR-based downhole logging tool in-situ, in accordance with embodiments of the present disclosure;

FIG. 5 depicts a flowchart of an embodiment of a method for calibrating an NMR-based downhole logging tool in-situ, including using a trained machine learning model to determine the wettability factor η_{w} from the relative movement of the oil and water T₂ peaks within a mixed-wet portion of a formation, in accordance with embodiments of the present disclosure;

FIG. 6 depicts an example of the shift in T₂ distributions as the NMR-based downhole logging tool travels through various zones of the formation, in accordance with embodiments of the present disclosure;

FIG. 7 depicts an example of the shift in T₂ distributions as the total water saturation S_{w} decreases from 0.25 and the wettability factor η_{w} decreases from approximately 0.95 to approximately 0.05; and

### DETAILED DESCRIPTION

Certain embodiments commensurate in scope with the present disclosure are summarized below. These embodiments are not intended to limit the scope of the disclosure, but rather these embodiments are intended only to provide a brief summary of certain disclosed embodiments. Indeed, the present disclosure may encompass a variety of forms that may be similar to or different from the embodiments set forth below.

As used herein, the term “coupled” or “coupled to” may indicate establishing either a direct or indirect connection (e.g., where the connection may not include or include intermediate or intervening components between those coupled), and is not limited to either unless expressly referenced as such. The term “set” may refer to one or more items. Wherever possible, like or identical reference numerals are used in the figures to identify common or the same elements. The figures are not necessarily to scale and certain features and certain views of the figures may be shown exaggerated in scale for purposes of clarification.

As used herein, the terms “inner” and “outer”; “up” and “down”; “upper” and “lower”; “upward” and “downward”; “above” and “below”; “inward” and “outward”; and other like terms as used herein refer to relative positions to one another and are not intended to denote a particular direction or spatial orientation. The terms “couple,” “coupled,” “connect,” “connection,” “connected,” “in connection with,” and “connecting” refer to “in direct connection with” or “in connection with via one or more intermediate elements or members.”

Furthermore, when introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment,” “an embodiment,” or “some embodiments” of the present disclosure are not intended to be interpreted as excluding the existence of additional embodiments that also incorporate the recited features. Furthermore, the phrase A “based on” B is intended to mean that A is at least partially based on B. Moreover, unless expressly stated otherwise, the term “or” is intended to be inclusive (e.g., logical OR) and not exclusive (e.g., logical XOR). In other words, the phrase A “or” B is intended to mean A, B, or both A and B.

In determining where to locate a well for the extraction of hydrocarbons, various procedures may be used to assess the commercial viability of and risk associated with a particular location. After seismic surveys have identified promising geological formations (e.g., a prospect), an exploration well may be drilled to collect additional information regarding the presence and characteristics (e.g., fluid quantity, viscosity, etc.) of a hydrocarbon reservoir. Nuclear magnetic resonance (NMR) may be used to gather some of this data, and NMR logging may be performed concurrently with (e.g., logging while drilling) or subsequently to the drilling of the exploration borehole.

NMR logging operations may gather data indicative of the T₁ distributions (e.g., longitudinal relaxation time) and T₂ distributions (e.g., transverse relaxation time) of the fluids within the formation. The T₁ and T₂ distributions may be useful in distinguishing between hydrocarbons and water within the formation, distinguishing between bound fluids and movable fluids, determining the viscosity of the fluids within the formation, and the like. Furthermore, the T₁ and T₂ distributions may be useful in determining the water-volume fraction of the reservoir and the wettability of the geological formation (e.g., the preference of the solid surface of the geological formation to be in contact with one fluid rather than another, such as water and/or hydrocarbons). Knowledge of these characteristics may be desirable to improve the recovery of hydrocarbons without causing damage to the reservoir and may assist in determining further properties of the well, such as relative permeability (e.g., how easily hydrocarbons may flow from the formation). These characteristics and/or properties may be utilized in further hydrocarbon recovery operations, for example, to determine whether to proceed with locating a well at the site of the formation, sizing and/or designing such a well, altering drilling parameters, generating economic predictions for the formation, and the like.

The NMR T₂ distributions of a fully-water saturated formation may be connected to the formation's partially saturated (e.g., water-wet, mixed-wet) T₂ distributions. That is, the distribution of T₂ relaxation signals when the pores of the formation are fully saturated with water may be correlated to the distribution of T₂ relaxation signals when the pores are partially saturated and/or saturated with water and hydrocarbons. To establish this connection, the corresponding fluid distribution (e.g., fluid volume fraction) and wettability characteristics (e.g., pore surface wetting fraction) of the formation may be used. These characteristics may be formation-specific and may be determined as a function of pore size in the formation. This determination may be facilitated using formation-specific parameters, such as the characteristic time that determines the inflection point in the T₂ space (T_{c}), the exponent that controls the sharpness of the saturation transition around the characteristic time (a), the water saturation levels (S_{w}), and the wettability factor (η_{w}) (e.g., describing the fraction of pore surfaces wetted by water versus the fraction of pore surfaces wetted by oil; interchangeably referred to as the “water-wetting surface fraction”). Furthermore, a parameter with the subscript “LT₂” may refer to the value of the formation-specific parameter for larger pores (e.g., approximately 50 μm, 60 μm, 70 μm, or greater). However, it may be difficult to efficiently and accurately determine these formation-specific parameters in-situ (e.g., in the field), while likewise inefficient, tedious, and/or costly to recreate the downhole conditions in a remote environment (e.g., in a lab).

With the foregoing in mind, the present embodiments include a method for an in-situ calibration of an NMR tool to determine the formation-specific parameters T_{c}, α, and η_{w,LT}_{₂}, while S_{w,LT}_{₂} may be determined through petrophysical interpretation of other logging tools. In the in-situ calibration technique, an NMR tool may be lowered to the bottom of a formation, where NMR logging of the T₂ distributions may begin. At the bottom of the formation, the NMR tool may be below the free water surface of the corresponding reservoir and the formation may be fully-water saturated (e.g., the water saturation levels S_{w} may be at a maximum value of 1). Furthermore, as oil and water are immiscible, the water-wetting surface fraction, η_{w,LT}_{₂}, may also be treated as equal to 1 (e.g., the pore surfaces may be assumed to be wetted by water only). The T₂ relaxation time from a fully-water saturated pore may follow Equation 1, where

$${T}_{2}^{f}$$

is the T₂ relaxation time of the fully-water saturated pore, T_{2,b,w} is the T₂ relaxation time of bulk water/brine, A is the pore surface area, Vis the pore volume,

$${T}_{2 , s}^{f}$$

is the surface T₂ relaxion time of the fully-water saturated pore with an effective size r, c is a geometric factor (e.g., 3 for spherical pores, 2 for tubular pores, 1 for flake-like pores, etc.), and ρ_{w} is the surface relaxivity of water. The surface T₂ relaxation time of the fully-water saturated pore may be directly proportional to the effective pore size r by a multiplication constant

$$\frac{1}{c {ρ}_{w}} ,$$

as shown by Equation 2. The T₂ relaxation time of bulk water/brine T_{2,b,w} may often take a value between 2-4 seconds.

$$\frac{1}{{T}_{2}^{f}} = \frac{1}{{T}_{2 , b , w}} + {ρ}_{w} \frac{A}{V} = \frac{1}{{T}_{2 , b , w}} + \frac{1}{{T}_{2 , s}^{f}} \qquad ( 1 )$$

$${T}_{2 , s}^{f} = \frac{r}{c {ρ}_{w}} \qquad ( 2 )$$

Thus, the surface T₂ relaxation time of a fully-water saturated pore

$$( {T}_{2 , s}^{f} )$$

may be directly proportional to pore size r. Furthermore, the surface T₂ relaxation time of a fully-water saturated pore

$$( {T}_{2 , s}^{f} )$$

may be used as a reference to determine the characteristic time, T_{c}, and the exponent that controls the sharpness of the saturation transition around the characteristic time, α, in other zones of the formation above the free water surface using Equation 3 and Equation 4, wherein

$$Φ ( {T}_{2 , s}^{f} )$$

is the water volume fraction in a pore with the fully-water saturated surface T₂ relaxation time

$${T}_{2 , s}^{f} .$$

$${S}_{w} = {\int }_{0}^{∞} F ( {T}_{2 , s}^{f} ) Φ ( {T}_{2 , s}^{f} ) d {T}_{2 , s}^{f} \qquad ( 3 )$$

$$Φ ( {T}_{2 , s}^{f} ) = \frac{1 + {{S}_{w , {LT}_{2}} [ \frac{{T}_{2 , s}^{f}}{{T}_{c}} ]}^{α}}{1 + {[ \frac{{T}_{2 , s}^{f}}{{T}_{c}} ]}^{α}} \qquad ( 4 )$$

Continuing to log the NMR tool upwards, NMR data (e.g., T₂ relaxation times) is collected as the formation transitions from fully water-saturated (e.g., when the NMR tool is below the free water level) to partially saturated water-wet. In this transition zone of the formation, the water-wetting surface fraction η_{w,LT}_{₂} may still be treated as equal to 1. The NMR data from the fully-water saturated zone may be used as a reference T₂ distribution, as the T₂ relaxation time of water and the T₂ relaxation time of oil in this zone may be predicted as a function of the surface T₂ relaxation time of the fully-water saturated pore

$$( {T}_{2 , s}^{f} )$$

using Equations 5 and 6, respectively, wherein T_{2,w} is the T₂ relaxation time of water and T_{2,o} is the T₂ relaxation time of oil.

$$Ω ( {T}_{2 , s}^{f} )$$

is the water-wetting surface fraction function, defined in Equation 7.

$$\frac{1}{{T}_{2 , w} ( {T}_{2 , s}^{f} )} = \frac{1}{{T}_{2 , b , w}} + {ρ}_{w} \frac{A Ω ( {T}_{2 , s}^{f} )}{V Φ ( {T}_{2 , s}^{f} )} = \frac{1}{{T}_{2 , b , w}} + \frac{Ω ( {T}_{2 , s}^{f} )}{Φ ( {T}_{2 , s}^{f} )} \frac{1}{{T}_{2 , s}^{f}} , \qquad ( 5 )$$

$$\frac{1}{{T}_{2 , o} ( {T}_{2 , s}^{f} )} = \frac{1}{{T}_{2 , b , o}} + {ρ}_{o} \frac{A [ 1 - Ω ( {T}_{2 , s}^{f} ) ]}{V [ 1 - Φ ( {T}_{2 , s}^{f} ) ]} = \frac{1}{{T}_{2 , b , o}} + \frac{1}{{γ}_{w / o}} \frac{1 - Ω ( {T}_{2 , s}^{f} )}{1 - Φ ( {T}_{2 , s}^{f} )} \frac{1}{{T}_{2 , s}^{f}} \qquad ( 6 )$$

$$Ω ( {T}_{2 , s}^{f} ) = \frac{1 + {{η}_{w , {LT}_{2}} [ \frac{{T}_{2 , s}^{f}}{{T}_{c}} ]}^{α}}{1 + {[ \frac{{T}_{2 , s}^{f}}{{T}_{c}} ]}^{α}} \qquad ( 7 )$$

This transition zone of the formation may yield multiple T₂ distributions in different saturation levels (e.g., at different depths of the formation) as the NMR tool travels upwards. Because the bulk oil peaks stay at the bulk oil peak value (e.g., the percentage of pore volume filled with oil in a porous rock) regardless of saturation level when the saturation level is, for example, between approximately 0.35 and 0.7, the bulk oil T₂ distributions may be fully segregated from the T₂ distributions of water for each saturation level. Water saturation levels (S_{w}) at corresponding depths may be determined from petrophysical interpretations of typical logging tools, allowing Equation 3 to be used to connect the multiple partially saturated water-wet T₂ distributions to the reference fully-water saturated T₂ distribution with the same values of α and T_{c} as determined using Equation 4. The values of α and T_{c} may be optimized (e.g., refining the determined values of α and T_{c}) at this stage by minimizing the difference between the predicted T₂ distributions of the partially saturated water-wet zone of the formation (e.g., Equations 5 and 6) and the measured T₂ distributions of the partially saturated water-wet zone of the formation, using the fully-water saturated T₂ distribution as a reference.

As the NMR tool continues traveling upwards and the water saturation level of the formation decreases to S_{w}≤0.25, the formation may become mixed-wet. Thus, the wettability factor, η_{w,LT}_{₂}, may take values between 0≤η_{w,LT}_{₂}≤1. In the mixed-wet zone of the formation, the additional unknown η_{w,LT}_{₂} may be estimated using the α and T_{c} values optimized at the transition (e.g., partially saturated water-wet) zone of the formation and water saturation level S_{w} values from petrophysical interpretations of other logging tools. Using Equation 5 and Equation 6 as a model to predict the T₂ relaxation signals and T_{2,s}^{f} as a reference, the wettability factor η_{w,LT}_{₂} may be estimated and/or refined (e.g., brought closer to a ground truth value) by minimizing the difference between the model predicted T₂ relaxation signals and the measured T₂ relaxation signals throughout the mixed-wet zone of the formation. This minimization of difference may be conducted in various domains (e.g., the time domain, the T₂ domain, the compressed data domain using singular value decomposition, etc.) and may generally follow Equation 8, wherein \tilde{d}ₚ is the perceived data vector from the measured T₂ relaxation signals

$$d ( {η}_{w , {LT}_{2}} , F ( {T}_{2 , s}^{f} ) )$$

is the data vector from the predicted T₂ relaxation signals, and Reg represents any prior regulations. Likewise, other cost functions (e.g., L₁-norm, L₂-norm, etc.) may be used to minimize the difference between the model predicted and the measured T₂ relaxation signals.
(8)

$$arg {min}_{{η}_{w , {LT}_{2}} , F ( {T}_{2 , s}^{f} )} ( {\vert {\tilde{d}}_{p} - d ( {η}_{w , {LT}_{2}} , F ( {T}_{2 , s}^{f} ) ) \vert}^{2} + R e g ) \qquad ( 8 )$$

Thus, as the NMR tool reaches the top of the formation and the calibration process is completed, the formation-specific parameters T_{c}, α, and η_{w,LT}_{₂} may be determined in-situ.

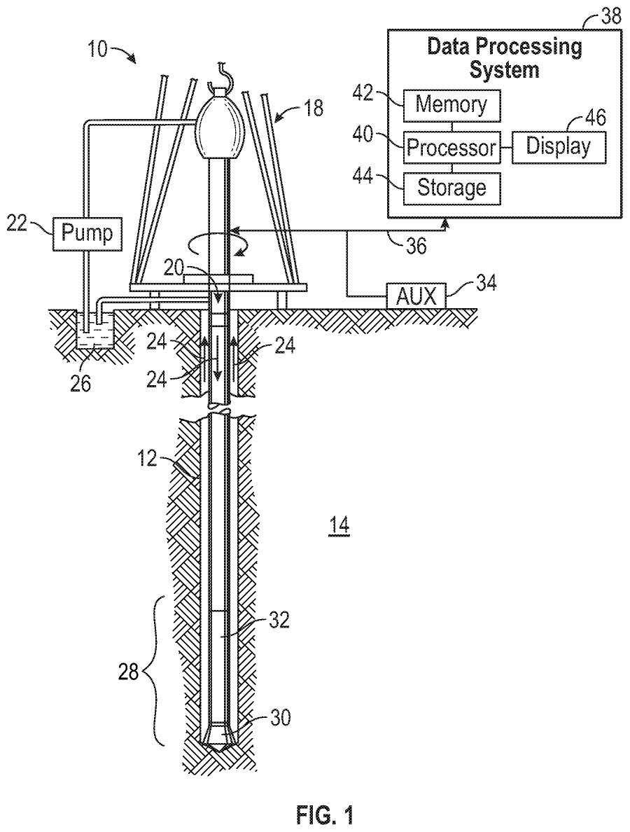

With the foregoing in mind, FIG. 1 illustrates a schematic view of a drilling system 10 that may employ the systems and methods of this disclosure. The drilling system 10 may be used to drill a borehole 12 into a geological region 14. In the drilling system 10, a drilling rig 18 may rotate a drill string 20 within the borehole 12. As the drill string 20 is rotated, a drilling fluid pump 22 may be used to pump drilling fluid, which may be referred to as “mud” or “drilling mud,” downward through the center of the drill string 20, and back up around the drill string 20, as shown by reference arrows 24. At the surface, return drilling fluid may be filtered and conveyed back to a mud pit 26 for reuse. The drilling fluid may travel down to the bottom of the drill string 20, known as the bottom-hole assembly (BHA) 28. The drilling fluid may be used to rotate, cool, and/or lubricate a drill bit 30 that may be a part of the BHA 28. The fluid may exit the drill string 20 through the drill bit 30 and carry drill cuttings away from the bottom of the borehole 12 back to the surface.

The BHA 28 may include the drill bit 30 along with the various downhole tools, such as one or more logging tools 32. The BHA 28 may thus convey the one or more logging tools 32 through the geological region 14 via the borehole 12. As described in greater detail herein, the one or more logging tools 32 may be any suitable downhole tool that emits electromagnetic energy (e.g., magnetic fields and radio frequency (RF) pulses) within the borehole 12 (e.g., a downhole environment). For instance, the one or more logging tools 32 may be nuclear magnetic resonance (NMR) logging tools. The downhole tools, which may include the one or more logging tools 32, may collect a variety of information relating to the geological region 14, such as fluid-filled porosity, relative permeability, pore size, wettability, and so forth. Likewise, the downhole tools may be measurement-while-drilling (MWD) tools, logging-while-drilling (LWD) tools, mapping-while drilling tools, and so forth, that measure certain drilling parameters, such as the temperature, pressure, orientation of the drill bit 30. It should be understood that, although FIG. 1 illustrates the one or more logging tools 32 included in the BHA 28 with drill bit 30, the one or more logging tools 32 may be conveyed through the geological region 14 via the borehole 12 subsequent to drilling operations.

The one or more logging tools 32 may receive energy from an electrical energy device or an electrical energy storage device, such as an auxiliary power source 34 or another electrical energy source to power the tool. In some embodiments, the one or more logging tools 32 may include a power source within the one or more logging tools 32, such as a battery system or a capacitator, to store sufficient electrical energy to emit and/or receive electromagnetic waves.

Communications 36, such as control signals, may be transmitted from a data processing system 38 (processing system 38) to the one or more logging tools 32, and communications 36, such as data signals related to the results/measurements of the one or more logging tools 32, may be returned to the data processing system 38 from the one or more logging tools 32. The data processing system 38 may be any electronic data processing system that can be used to carry out the systems and methods of this disclosure. For example, the data processing system 38 may include one or more processors 40, which may execute instructions stored in memory 42 and/or storage 44. The memory 42 and/or the storage 44 of the data processing system 38 may be any suitable article of manufacture that can store the instructions. In certain embodiments, the one or more processors 40 may include a microprocessor, a microcontroller, a processor module or subsystem, a programmed integrated circuit, a programmable gate array, a digital signal processor (DSP), or another control or computing device. In certain embodiments, the one or more processors 40 may include machine learning (ML) and/or artificial intelligence (AI) based processors, such as neural processing units (NPUs). Likewise, the one or more processors 40 may operate to implement a trained ML model as part of an AI processing system.

In certain embodiments, the memory 42 and storage 44 are implemented as one or more non-transitory computer-readable or machine-readable storage media. In certain embodiments, the memory 42 may include one or more different forms of memory, including semiconductor memory devices, such as dynamic or static random access memories (DRAMs or SRAMs), erasable and programmable read-only memories (EPROMs), electrically erasable and programmable read-only memories (EEPROMs), and flash memories. The storage 44 may include solid state drives (SSDs); magnetic disks such as fixed, floppy and removable disks; other magnetic media including tape; optical media such as compact disks (CD) or digital video disks (DVDs); or other types of storage devices. Note that the computer-executable instructions and associated data of the analysis module(s) may be provided on one computer-readable or machine-readable storage medium of the memory 42 or the storage 44, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the storage 44 may be located either in the machine running the machine-readable instructions or may be located at a remote site from which the machine-readable instructions may be downloaded over a network for execution.

As illustrated, the data processing system 38 may optionally also include a display 46, which may be any suitable electronic display, and may display images generated by the processor 40. The data processing system 38 may be a local component of the drilling system 10 (e.g., at the surface), within the one or more logging tools 32 (e.g., downhole), a device located proximate to the drilling operation, and/or a remote data processing device located away from the drilling system 10 to process downhole measurements in real time or sometime after the data has been collected. In some embodiments, the data processing system 38 may be a portable computing device (e.g., tablet, smart phone, or laptop) or a server remote from the drilling system 10. In some embodiments, the one or more logging tools 32 may store and process collected data in the BHA 28 or send the data to the surface for processing via communications 36 described above, including any suitable telemetry (e.g., electrical signals pulsed through the geological region 14 or mud pulse telemetry using the drilling fluid).

It should be noted that, although the discussion above relates to a drilling system, other downhole equipment or systems may employ the systems and methods of this disclosure. For example, a downhole tool with one or more logging tools 32 conveyed by slickline, coiled tubing, wireline, or other delivery systems, may utilize the disclosed systems and methods.

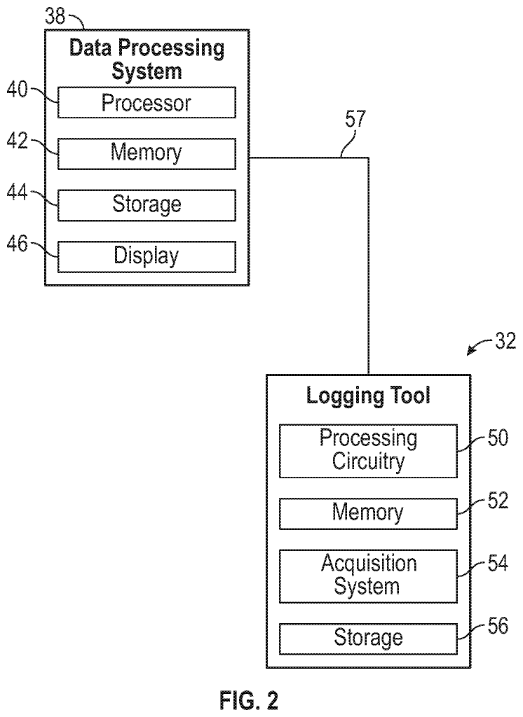

In one embodiment, data collected by the one or more logging tools 32 may be received by the data processing system 38. For example, FIG. 2 illustrates a block diagram of the data processing system 38 that is communicatively coupled to a logging tool 32. In the illustrated embodiment, a logging tool 32 includes processing circuitry 50, memory 52, an acquisition system 54, and storage 56. It should be understood, however, that in some embodiments, certain illustrated components of the logging tool 32 may be omitted. For instance, in some embodiments, data collected by the acquisition system 54 may be transmitted directly to the data processing system 38. In some embodiments, the processing circuitry 50 may include an Application-Specific Integrated Circuit (ASIC), Field-Programmable Gate Array (FPGA), a Micro Control Unit (MCU), a DSP, and the like that operate on high integer value data (e.g., having 16-bit resolution, 32-bit resolution, 64-bit resolution, etc.). In addition, the processing circuitry 50 may include one or more neural processing units (NPUs) that operate on reduced integer value data (e.g., 4-bit resolution, 8-bit resolution, etc.) that has a lower value than the high integer value data discussed above. In some embodiments, the logging tool 32 may communicate with the data processing system 38 via a data cable 57, telemeter, or other suitable techniques. For example, the logging tool 32 may communicate measurements obtained by one or more sensors (or meters) as part of the acquisition system 54. In turn, a processor 40 of the surface control system may determine certain parameters (e.g., fluid-filled porosity, pore size, water saturation, relative permeability, T₂ relaxation times, and so forth) based on the measurements. In such embodiments, the acquisition system 54 may include an emission source (e.g., an antenna) to acquire, obtain, or otherwise measure measurements.

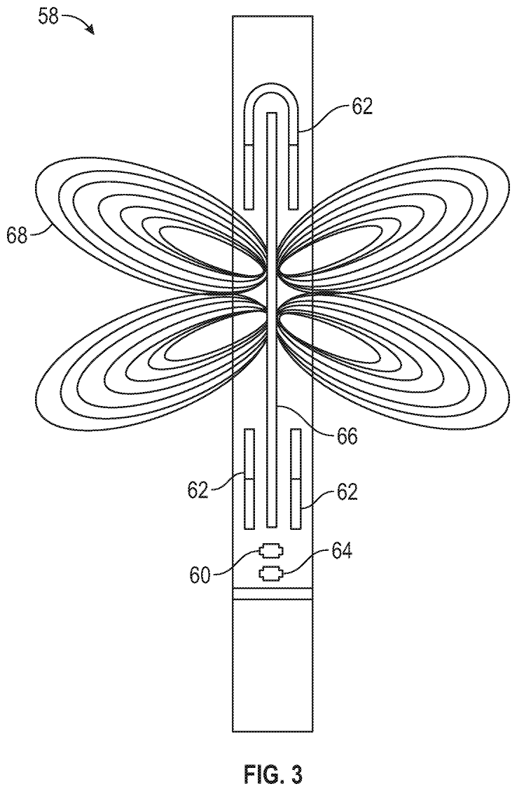

FIG. 3 illustrates a schematic view of an example nuclear magnetic resonance (NMR) logging tool 58 that can be utilized as the logging tool 32. It should be noted that the components and/or geometries of the NMR logging tool 58 may be other than as illustrated, and the schematic view depicted in FIG. 3 is merely for explanatory purposes. Furthermore, while the discussion herein will focus upon embodiments using proton nuclear magnetic resonance (1H-NMR), any suitable NMR technique may be used (e.g., Carbon-13 NMR, etc.). The NMR logging tool 58 (e.g., nuclear magnetic resonance logging tool 58), as illustrated, includes permanent magnets 62, which operate to produce a static magnetic field (B₀) (not illustrated). As should be understood by one of ordinary skill in the art, the permanent magnets 62 may possess geometries other than as illustrated (e.g., cylindrical “Jasper Jackson” structures, “saddle point” design, etc.). As the NMR logging tool 58 passes through the surrounding formation, the permanent magnets 62 may align the magnetic moments of hydrogen nuclei within the surrounding pores with the static magnetic field B₀. Additionally, the NMR logging tool 58 includes a radio-frequency (RF) antenna 66, which may operate as both a transmitter (e.g., transmitting RF pulses into the surrounding formation) and a receiver (e.g., detecting the weaker electromagnetic fields emitted by hydrogen nuclei as they relax). In some embodiments, the antenna 66 may take the form of a copper coil. In at least one embodiment, the antenna 66 may be a turbine-powered antenna. The magnetic field (B₁) 68 may be emitted from the antenna 66 into the surrounding formation. The NMR logging tool 58 may further include downhole electronics such as the controller 60 and/or telemetry device 64. The controller 60 may include a RF pulse circuit, which may operate to generate the radio frequency pulse sequences (e.g., RF pulse sequences, such as the Carr-Purcell-Meiboom-Gill (CPMG) sequence) used to manipulate nuclear spins of local hydrogen nuclei. That is, a high-energy RF pulse may induce a transverse magnetization of hydrogen nuclei within the formation. The RF pulse sequences generated by the controller 60 may be bursts of current passed through the antenna 66 to produce the magnetic field 68. The controller 60 may further tune the frequency of such pulse sequences to match the Larmor frequency, which may be dependent upon the static magnetic field B₀, produced by the permanent magnets 62. In some embodiments, the controller 60 may rapidly switch between different radio frequencies to enable faster and more detailed logging operations. Immediately after the RF pulse sequence, the antenna 66 may “listen” to the protons (e.g., hydrogen nuclei) returning to alignment; as the positive charges (e.g., protons) return to alignment, the movement (e.g., precession) of the charges may induce a faint voltage in the antenna 66. The downhole electronics (e.g., the controller 60 and/or the telemetry device 64) may also include a preamplifier, which may operate to amplify the micro-voltages induced in the antenna 66 and/or filter background borehole noise. These amplified voltages may then be digitized by the controller 60 and passed to the surface by the telemetry device 64. For instance, the telemetry device 64 may pass the digitized data from the controller 60 to the surface via a wired connection or the like, such as to the data processing system 38 of FIG. 2 via data cable 57. The digitized data may be interpreted at the surface and used in further natural resource operations (e.g., operational decision-making, wellsite planning and/or sizing, risk assessment, etc.).

Returning to FIG. 2, in certain embodiments, the data processing system 38 may include one or more analysis modules (e.g., a program of computer-executable instructions and associated data) that may be configured to perform various functions of the embodiments described herein. In certain embodiments, to perform these various functions, the one or more analysis modules may be executed on one or more processors 40 of the data processing system 38, which may be connected to memory 42 and storage 44 in which the one or more analysis modules may be stored.

In certain embodiments, the computer-executable instructions of the one or more analysis modules, when executed by the one or more processors 40, may cause the one or more processors 40 to generate one or more models (e.g., forward model, inverse model, mechanical model, and so forth). Such models may be used by the processing system 38 to calibrate the logging tool 32 and predict values of formation characteristics and/or properties that may or may not be measured (e.g., using gauges, sensors, and so forth) during well operations.

One technique for generation of the models for a formation by the processing system may include acquiring data via the logging tool 32 and transmitting that data to the processing system 38 for interpretation (e.g., calibration of the logging tool 32). The interpretation of the measured data by the processing system 38 can include performance of an inversion by the processing system 38 in which the measured data received from the logging tool 32 is utilized to infer a parameter to be calculated using a forward model (e.g., determining inputs from outputs, such as determining the formation-specific parameters from the measured T₂ distributions and a model that predicts T₂ distributions). This can include iteration utilizing the forward model until a difference (or error) between measured data and the parameter being estimated to generate an output is minimized (or is less than a predetermined threshold). However, in other embodiments, the data interpretation typically performed by the data processing system 38 can instead be transferred from the surface to the logging tool 32 itself. That is, both the measurement of data as well as its interpretation may be performed directly in the downhole tool (e.g., the logging tool 32). Once generated, the interpretation results (e.g., the formation-specific parameters) can be sent from the downhole tool to the surface (e.g., to the data processing system 38).

As will be discussed in greater detail below, the determination of the formation-specific parameters (e.g., T_{c}, α, η_{w,LT}_{₂}) by the processing system 38 or the logging tool 32 may be performed using a trained machine learning model in real-time or in near-real time. Moreover, techniques described herein allow for the interpretation to be undertaken using physics-based modeling (e.g., computational representations of systems that use fundamental physical laws and/or mathematical equations to simulate and/or predict behavior).

Examples of the calibration of the logging tool 32 (e.g., interpreting measured data from the logging tool 32 to determine formation-specific parameters) will be discussed herein with respect to the logging tool 32 measuring the T₂ relaxation times of the fluids (e.g., hydrocarbons, water) at various depths of the formation. For example, as the logging tool 32 ascends through the formation, a transmitter (e.g., the antenna 66 of FIG. 3) and a sensor (e.g., the antenna 66 of FIG. 3) as part of the acquisition system 54 may transmit a radio-frequency pulse into the local formation, manipulating the nuclear spins of hydrogen nuclei, and subsequently detect electromagnetic fields over time as the hydrogen nuclei return to alignment and lose phase coherence. As will be discussed herein, the logging tool 32 may be calibrated using the detected electromagnetic fields, and the formation-specific parameters (e.g., T_{c}, α, η_{w}) may be determined.

Examples of the calibration of the logging tool 32 (e.g., interpretation of measured data from the logging tool 32 to determine formation-specific parameters) will be discussed herein with respect to the logging tool 32 measuring the T₂ relaxation times of hydrogen nuclei in the pores of a surrounding formation. For example, the antenna 66 as depicted in FIG. 3 may employ the CPMG pulse sequence to emit a 90° RF pulse to tip the local hydrogen protons into the transverse plane (e.g., the x-y plane) and, after a short delay, emit a 180° RF pulse to realign the hydrogen protons. The realignment of the hydrogen protons may generate a surge in signal strength, a “spin echo,” that may be detected by the antenna 66. The 180° RF pulse may be repeated hundreds or thousands of times to generate a train of spin echoes (e.g., an “echo train”), which may be plotted over time to form a multi-exponential decay curve. This multi-exponential decay curve may further be transformed (e.g., an inverse Laplace transform) into a T₂ distribution. Using these echo trains, collected as the logging tool 32 is logged upwards through the geological formation, the logging tool 32 may be calibrated and formation-specific parameters (e.g., the characteristic time that determines the inflection point in the T₂ space (T_{c}), the exponent that controls the sharpness of the saturation transition around the characteristic time (α), and the water-wetting surface fraction (η_{w})) may be determined.

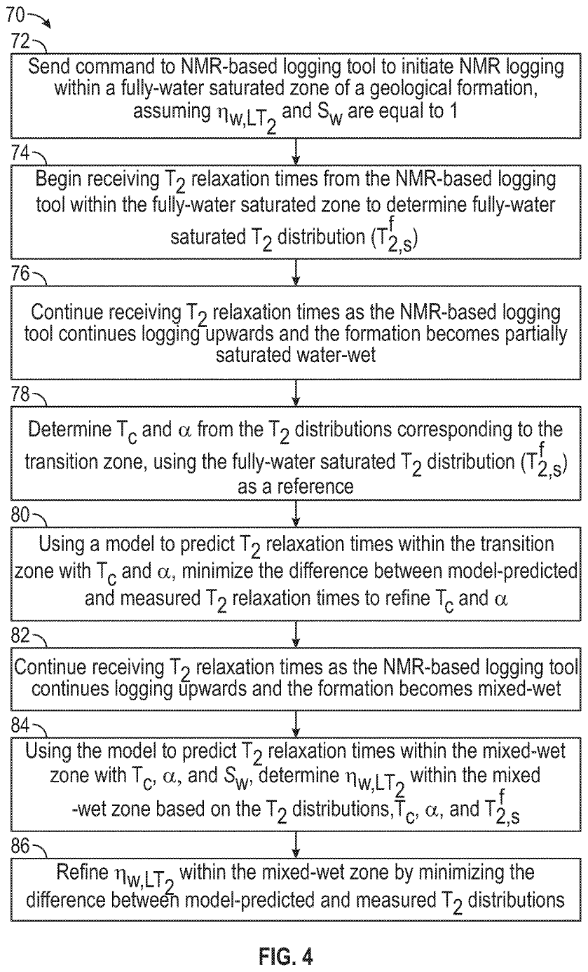

FIG. 4 depicts a flow chart describing implementation of an in-situ calibration process 70 of an NMR-based logging tool, such as the logging tool 32 depicted in FIG. 2, in accordance with aspects of the present disclosure. The in-situ calibration process 70 may be carried out by any suitable data processing system, such as, for example, the data processing system 38 depicted in FIG. 2. In some embodiments, in-situ calibration process 70 can be performed by one or more processors (e.g., processor 40) executing instructions stored in memory (e.g., memory 42) to perform the techniques described in conjunction with FIG. 4. The in-situ calibration process 70 will be discussed as being performed by the data processing system 38 of FIG. 1, however, as noted above, in-situ calibration process 70 can additionally and/or alternatively be performed by a cloud computing device or a remote computing device.

In some embodiments, the data processing system 38 may include or function as a control system. Furthermore, in some embodiments, the data processing system 38 may be a remote processing system (e.g., located off-site and in communication with the NMR-based logging tool or another processing system). Although the in-situ calibration process 70 will be described in a particular order, it should be noted that the in-situ calibration process 70 may be performed in any suitable order, and certain steps may be omitted and/or added to the in-situ calibration process 70 without departing from the present disclosure.

In the in-situ calibration process 70, a data processing system 38 may be in communication with an NMR-based logging tool and may be configured to receive data indicative of T₂ relaxation times from the NMR-based logging tool. The NMR-based logging tool may be part of a drillstring, such as included in the bottom-hole assembly (BHA), to allow the NMR-based logging tool to be conveyed through a borehole drilled into a formation of interest. In some embodiments, the in-situ calibration process 70 may be conducted as a logging while drilling (LWD) process or conducted after drilling the borehole. However, it should be noted that various portions of the flowchart may be performed remotely. That is, while the in-situ calibration process 70 may be discussed herein as being performed as the NMR-based logging tool is logged through the geological formation, in some embodiments, one or more of the formation-specific parameters (e.g., T_{c}, α, and/or η_{w,LT}_{₂}) may be determined after the NMR-based logging tool has logged the entire geological formation or a portion of the geological formation. Furthermore, in some embodiments, the data received from the NMR-based logging tool may be used to determine one or more of the formation-specific parameters (e.g., T_{c}, α, and/or η_{w,LT}_{₂}) remotely.

Keeping this in mind, the in-situ calibration process 70 may begin at block 72 by sending a command to the NMR-based logging tool to initiate NMR logging when the NMR-based logging tool is within a fully-water saturated zone of a geological formation. For instance, the drillstring may be lowered, conveying the NMR-based logging tool to the bottom of the formation into which a borehole has been drilled (or is being drilled). Because oil and water are immiscible, the bottom of the formation may be beneath the water surface of the reservoir (e.g., below the interface between hydrocarbons and water within the reservoir, and the fluid within this section of the formation may be fully water, referred to herein as the fully-water saturated zone). With the formation being fully in contact with only water at this depth, the water saturation S_{w} and the water-wetting surface fraction η_{w,LT}_{₂} may each be assumed to be approximately equal to 1. When the NMR-based logging tool is within the fully-water saturated zone, a control system, such as the data processing system 38 depicted in FIG. 2 or any other suitable data processing system, may send a command to the NMR-based logging tool to initiate NMR logging at block 72. As the data processing system 38 prepares to begin receiving data indicative of T₂ relaxation times from the NMR-based logging tool at block 74, it may assume that the water saturation S_{w} and the water-wetting surface fraction η_{w,LT}_{₂} corresponding to the fully-water saturated T₂ relaxation times are equal to 1.

Proceeding to block 74, the data processing system 38 may begin receiving data indicative of T₂ relaxation times of the fully-water saturated pore within the borehole from the NMR-based logging tool. Within the fully-water saturated zone (e.g., at the bottom of the formation), the surface relaxation time may dominate the measured T₂ relaxation times, and the distribution of the received T₂ relaxation times may thus be associated with T_{2,s}^{f}, the surface T₂ relaxation time of the fully-water saturated pore. Using Equation 1 (reproduced below), the T₂ relaxation time of the fully-water saturated pore (T₂^{f}) may be transformed into the surface T₂ relaxation time of the fully-water saturated pore (T_{2,s}^{f}) via the data processing system 38. In Equation 1, T_{2,b,w} is the T₂ relaxation time of bulk water/brine (assumed to be known, generally falling between approximately 2-4 seconds), ρ_{w} is the surface relaxivity of water, A is the pore surface area, and V is the pore volume. The data processing system 38 may store T_{2,s}^{f} as a reference to determine the formation-specific parameters (e.g., T_{c}, α, η_{w,LT}_{₂}) while the NMR logging tool continues to pass through the formation.

$$\frac{1}{{T}_{2}^{f}} = \frac{1}{{T}_{2 , b , w}} + {ρ}_{w} \frac{A}{V} = \frac{1}{{T}_{2 , b , w}} + \frac{1}{{T}_{2 , s}^{f}} \qquad ( 1 )$$

While the NMR-based logging tool continues to pass through the formation at block 76, the data processing system 38 may continue to receive data indicative of T₂ relaxation times within the formation. As the NMR-based logging tool ascends within the formation and exits the fully-water saturated zone, the formation may begin to transition from fully-water saturated to partially saturated water-wet (e.g., entering the transition zone). Within the transition zone of the formation, the water saturation S_{w} may take values within a range of 1 to approximately 0.3 (e.g, between 1 and approximately 0.35, approximately 0.30, approximately 0.25, etc.), while the data processing system 38 may continue to assume the wettability factor η_{w,LT}_{₂} (e.g., the water-wetting surface fraction) is equal to 1. The water saturation S_{w} may be determined by any suitable process, such as via petrophysical interpretation of data from typical logging tools (e.g., calculated from resistivity well logs by relating S_{w} to porosity, connate-water resistivity, and various rock electrical properties; oil-based mud (OBM)-core-plug Dean-Stark water-volume determinations, etc.).

At block 78, the data processing system 38 may use the T₂ relaxation times from the transition zone to determine the formation-specific parameters T_{c} and α. To determine the formation-specific parameters, the data processing system 38 may use the surface T₂ relaxation time of the fully-water saturated pore (determined within the fully-water saturated zone of the formation, as described above) as a reference T₂ distribution. In some embodiments, the data processing system 38 may use Equations 5 and 6 (reproduced below) as a model to predict the T₂ relaxation times within the formation, where Ω is defined by Equation 7 and Φ is defined by Equation 4. Furthermore, γ_{w/o} represents the surface relaxivity ratio between water and oil (e.g., γ_{w/o}=ρ_{w}/ρₒ). In some embodiments, the surface relaxivity ratio may be assumed to be 3 (e.g., γ_{w/o}=3).

$$\frac{1}{{T}_{2 , w} ( {T}_{2 , s}^{f} )} = \frac{1}{{T}_{2 , b , w}} + {ρ}_{w} \frac{A Ω ( {T}_{2 , s}^{f} )}{V Φ ( {T}_{2 , s}^{f} )} = \frac{1}{{T}_{2 , b , w}} + \frac{Ω ( {T}_{2 , s}^{f} )}{Φ ( {T}_{2 , s}^{f} )} \frac{1}{{T}_{2 , s}^{f}} \qquad ( 5 )$$

$$\frac{1}{{T}_{2 , o} ( {T}_{2 , s}^{f} )} = \frac{1}{{T}_{2 , b , o}} + {ρ}_{o} \frac{A [ 1 - Ω ( {T}_{2 , s}^{f} ) ]}{V [ 1 - Φ ( {T}_{2 , s}^{f} ) ]} = \frac{1}{{T}_{2 , b , o}} + \frac{1}{{γ}_{w / o}} \frac{1 - Ω ( {T}_{2 , s}^{f} )}{1 - Φ ( {T}_{2 , s}^{f} )} \frac{1}{{T}_{2 , s}^{f}} \qquad ( 6 )$$

$$Ω ( {T}_{2 , s}^{f} ) = \frac{1 + {{η}_{w , {LT}_{2}} [ \frac{{T}_{2 , s}^{f}}{{T}_{c}} ]}^{α}}{1 + {[ \frac{{T}_{2 , s}^{f}}{{T}_{c}} ]}^{α}} \qquad ( 7 )$$

$$Φ ( {T}_{2 , s}^{f} ) = \frac{1 + {{S}_{w , {LT}_{2}} [ \frac{{T}_{2 , s}^{f}}{{T}_{c}} ]}^{α}}{1 + {[ \frac{{T}_{2 , s}^{f}}{{T}_{c}} ]}^{α}} \qquad ( 4 )$$

Keeping Equations 5 and 6 in mind, the data processing system 38 may use the water saturation S_{w}, determined via petrophysical interpretation of other logging data as described above, Equation 3 (reproduced below), and Equation 4 (reproduced above) to determine T_{c} and α. That is, using Equation 4 to define

$$Φ ( {T}_{2 , s}^{f} ) ,$$

the data processing system 38 may solve Equation 3 to determine T_{c} and α. Because the same values of T_{c} and α may be used within the fully-water saturated zone and the transition zone of the formation, the data processing system 38 may connect the fully-water saturated T₂ distribution and the T₂ distributions from the transition zone. Thus, the T₂ distributions within the transition zone may be predicted as well using Equation 5 and Equation 6 as a model.

$${S}_{w} = {\int }_{0}^{∞} F ( {T}_{2 , s}^{f} ) Φ ( {T}_{2 , s}^{f} ) d {T}_{2 , s}^{f} \qquad ( 3 )$$

Using Equations 5 and 6 as a model, the data processing system 38 may predict the T₂ relaxation times within the transition zone at block 80 with the values of T_{c} and α determined at block 78. After determining T_{c} and α with Equation 3 at block 78, the determined values of T_{c} and α may be refined by minimizing the difference between the model-predicted values (e.g., using Equations 5 and 6 to represent T_{2,s}^{f}) and the actual measured values (e.g., using the measured T₂ relaxation times from the mixed-wet zone), using the T_{2,s}^{f} distribution from the fully-water saturated zone as a reference. Furthermore, because hydrocarbon T₂ peaks stay at the previously determined bulk oil peak value regardless of changes in water saturation S_{w} (e.g., 0.3<S_{w}<0.7) the T₂ distribution of bulk hydrocarbons (T_{2,b,o}) within the formation may be segregated from the measured T₂ relaxation times. In the event that bulk hydrocarbon and water T₂ signals are not clearly separable from the T₂ distributions, the T₁−T₂ map and/or the D−T₂ map may be used to disentangle the signals from each other. Thereby, the bulk hydrocarbon T₂ distributions may be separated from the water T₂ distributions, which may enable more accurate model predictions using Equation 5 (e.g., modeling the T₂ distribution of bulk water) and Equation 6 (e.g., modeling the T₂ distribution of bulk hydrocarbons).

In some embodiments, blocks 78 and 80 may be a recapitulatory process, with T_{c} and α being refined throughout the transition zone of the formation, and blocks 76, 78, and 80 (e.g., receiving T₂ relaxation times, determining T_{c} and α within the transition zone, and refining T_{c} and α) may occur synchronously until the NMR logging tool exits the transition zone.

After determining and/or refining the values of T_{c} and α, the data processing system 38 may continue receiving T₂ relaxation times at block 82 as the NMR-based logging tool exits the transition zone and the formation becomes partially saturated mixed-wet (e.g., S_{w}≤0.3). Within the mixed-wet zone of the formation, the formation may be partially saturated with water and/or hydrocarbons. Therefore, the water-wetting surface fraction, η_{w,LT}_{₂}, may no longer be assumed to be approximately equal to 1 (e.g., 0≤η_{w,LT}_{₂}≤1). However, the additional unknown (the water-wetting surface fraction, η_{w,LT}_{₂}) may be estimated at block 84 using Equations 5 and 6 as a model with the values of T_{c} and α determined and/or refined at blocks 78 and 80, as well as water saturation (S_{w}) levels determined via petrophysical interpretation of typical logging tools. In some embodiments, the data processing system 38 may determine the water-wetting surface fraction η_{w,LT}_{₂} continuously or iteratively by depth within the formation.

Proceeding to block 84, the data processing system 38 may again use Equations 5 and 6 as a model to predict the T₂ relaxation times of bulk water and bulk hydrocarbons within the mixed-wet zone of the formation, as well as the T₂ distribution from the fully-water saturated zone (T_{2,s}^{f}) as a reference to estimate the water-wetting surface fraction η_{w,LT}_{₂}. Within the mixed-wet zone of the formation, the water-wetting surface fraction η_{w,LT}_{₂} may take different values at different depths. Thus, block 84 may be performed repeatedly in some embodiments as the NMR logging continues through various depths.

Proceeding to block 86, the value(s) of the water-wetting surface fraction η_{w,LT}_{₂} may be refined by minimizing the difference between the model predictions (e.g., the value(s) of η_{w,LT}_{₂} determined using Equations 5 and 6 as a model) and the actual measured T₂ values from the mixed-wet zone. That is, at block 86, the value(s) of the water-wetting surface fraction η_{w,LT}_{₂} may be adjusted until the T₂ relaxation times output from the model (e.g., Equation 5 and Equation 6) are approximately equal to the T₂ relaxation times measured by the NMR-based logging tool within the mixed-wet zone of the formation. In some embodiments, the minimization may generally take the form of Equation 8 (e.g., determining the arguments of the minima), though any suitable cost functions (e.g., L₁-norm, etc.) may be used to minimize the difference between the model-predicted values and the measured T₂ relaxation signals. The minimization may be conducted in any suitable domain, such as, for example, the time domain, the T₂ domain, the compressed data domain using singular decomposition, and the like. Within Equation 8, \tilde{d}ₚ may be the perceived data vector from the measured T₂ relaxation signals,

$$d ( {η}_{w , {LT}_{2}} , F ( {T}_{2 , s}^{f} ) )$$

may be the data vector from the predicted T₂ relaxation signals (e.g., using Equations 5 and 6 as a model), and Reg represents any prior regulations (e.g., limiting the water-wetting surface fraction η_{w,LT}_{₂} to a value between 0 and 1, etc.). In some embodiments, blocks 84 and 86 may be performed synchronously, and may be performed repeatedly as the NMR logging continues through various depths.

$$arg {min}_{{η}_{w , L {T}_{2}} , F ( {T}_{2 , s}^{f} )} ( {\vert {\tilde{d}}_{p} - d ( {η}_{w , {LT}_{2}} , F ( {T}_{2 , s}^{f} ) ) \vert}^{2} + R e g ) \qquad ( 8 )$$

After minimizing the difference between the model-predicted values and the measured T₂ relaxation signals at block 82, the NMR-based logging tool may be calibrated and the formation-specific parameters T_{c}, α, and η_{w,LT}_{₂} may have been determined. In some embodiments, the formation-specific parameters may be used to characterize the well, as well as determining well characteristics such as the water-volume fraction of the reservoir, the wettability of the formation, the relative permeability of the formation, and the like, without requiring time-consuming core measurements and/or recreations of the formation within a lab. These well characteristics may be useful in planning a hydrocarbon production operation (e.g., to determine a hydrocarbon production schedule, to produce hydrocarbons from the well without damaging the reservoir, and the like). Additionally, the overall wettability index of the formation, I_{w}, may be determined according to, for example, Equation 9. In some embodiments, the integration

$${\int }_{0}^{∞} F ( {T}_{2 , s}^{f} ) d {T}_{2 , s}^{f}$$

may be normalized to

$$1 ( e . g . , {\int }_{0}^{∞} F ( {T}_{2 , s}^{f} ) d {T}_{2 , s}^{f} = 1 )$$

to yield Equation 10. Moreover, the formation-specific parameters, the well characteristics, and/or the overall wettability index may be used in further models of the well.

$${I}_{w} = {\int }_{0}^{∞} F ( {T}_{2 , s}^{f} ) Ω ( {T}_{2 , s}^{f} ) d {T}_{2 , s}^{f} - {\int }_{0}^{∞} F ( {T}_{2 , s}^{f} ) [ 1 - Ω ( {T}_{2 , s}^{f} ) ] d {T}_{2 , s}^{f} \qquad ( 9 )$$

$${I}_{w} = 2 {\int }_{0}^{∞} F ( {T}_{2 , s}^{f} ) Ω ( {T}_{2 , s}^{f} ) d {T}_{2 , s}^{f} - 1 \qquad ( 10 )$$

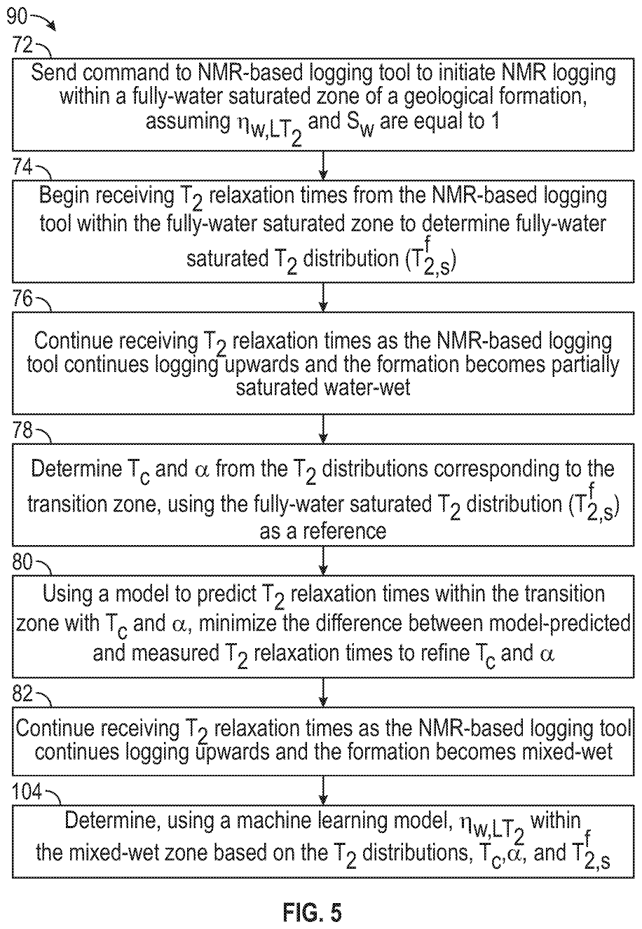

FIG. 5 depicts a flow chart describing implementation of an in-situ machine learning-assisted calibration process 90 of an NMR-based logging tool, such as the logging tool 32 depicted in FIG. 2, in accordance with aspects of the present disclosure. The in-situ machine learning-assisted calibration process 90 may be carried out by any suitable data processing system, such as, for example, the data processing system 38 depicted in FIG. 2. In some embodiments, in-situ calibration process 90 can be performed by one or more processors (e.g., processor 40) executing instructions stored in memory (e.g., memory 42) to perform the techniques described in conjunction with FIG. 4. The in-situ machine learning-assisted calibration process 90 will be discussed as being performed by the data processing system 38 of FIG. 1, however, as noted above, in-situ machine learning-assisted calibration process 90 can additionally and/or alternatively be performed by a cloud computing device or a remote computing device.

In some embodiments, the data processing system 38 may include or function as a control system. Although the in-situ machine learning-assisted calibration process 90 will be described in a particular order, it should be noted that the in-situ machine learning-assisted calibration process 90 may be performed in any suitable order, and certain steps may be omitted and/or added to the in-situ machine learning-assisted calibration process 90 without departing from the present disclosure.

In the in-situ machine learning-assisted calibration process 90, a data processing system 38 may be in communication with an NMR-based logging tool and may be configured to receive data indicative of T₂ relaxation times from the NMR-based logging tool. The NMR-based logging tool may be part of a drillstring, such as included in the bottom-hole assembly (BHA), to allow the NMR-based logging tool to be conveyed through a borehole drilled into a formation of interest. In some embodiments, the in-situ machine learning-assisted calibration process 90 may be conducted as a logging while drilling (LWD) process or conducted after drilling the borehole.

Furthermore, the data processing system 38 may include or be in communication with a machine learning model trained to estimate water-wetting surface fraction values (η_{w,LT}_{₂}), based on the relative movement of hydrocarbon and water peaks within a measured T₂ distribution. The machine learning model may, for example, be a neural network and/or a deep learning model, though any suitable machine learning model may be used. For instance, consider one or more examples of a deep learning model, such as a deep Boltzmann machine, a deep belief network, a convolutional neural network (CNN), a stacked auto-encoder, etc.; an ensemble model, such as a random forest model, a gradient boosting machine, a bootstrapped aggregation model, an AdaBoost model, a stacked generalization model, a gradient boosted regression tree model, etc.; a neural network model, such as a radial basis function network, perceptron, back-propagation, Hopfield network, etc.; a regularization model, such as linear regression, ordinary least squares regression, stepwise regression, multivariate adaptive regression splines, locally estimated scatterplot smoothing, logistic regression, etc.; a Bayesian model (e.g., naïve Bayes, average-on-dependence estimators, Bayesian belief network, Gaussian naïve Bayes, multinomial naïve Bayes, Bayesian network, etc.; a decision tree model, such as classification and regression tree, iterative dichotomiser 3, C4.5, C5.0, chi-squared automatic interaction detection, decision stump, conditional decision tree, M5, etc.; a dimensionality reduction model, such as principal component analysis, partial least squares regression, Sammon mapping, multidimensional scaling, projection pursuit, principal component regression, partial least squares discriminant analysis, mixture discriminant analysis, quadratic discriminant analysis, regularized discriminant analysis, flexible discriminant analysis, linear discriminant analysis, etc.; an instance model, such as k-nearest neighbor, learning vector quantization, self-organizing map, locally weighted learning, etc.; a clustering model, such as k-means, k-medians, expectation maximization, hierarchical clustering, etc.; and the like.

Keeping this in mind, blocks 72, 74, 76, 78, 80, and 82 of the in-situ machine learning-assisted calibration process 90 may generally follow and/or correspond to blocks 72, 74, 76, 78, 80, and 82, respectively, of the in-situ calibration process 70 depicted in FIG. 4 and as discussed above. That is, the in-situ machine learning-assisted calibration process 90 may mirror the in-situ calibration process 70 through block 82 of the in-situ machine learning-assisted calibration process 90. However, at block 104, the in-situ machine learning-assisted calibration process 90 may use a trained machine learning model in lieu of minimizing the difference between the model-predicted T₂ relaxation times (e.g., Equations 5 and 6) and the measured T₂ relaxation times, as will be discussed herein.

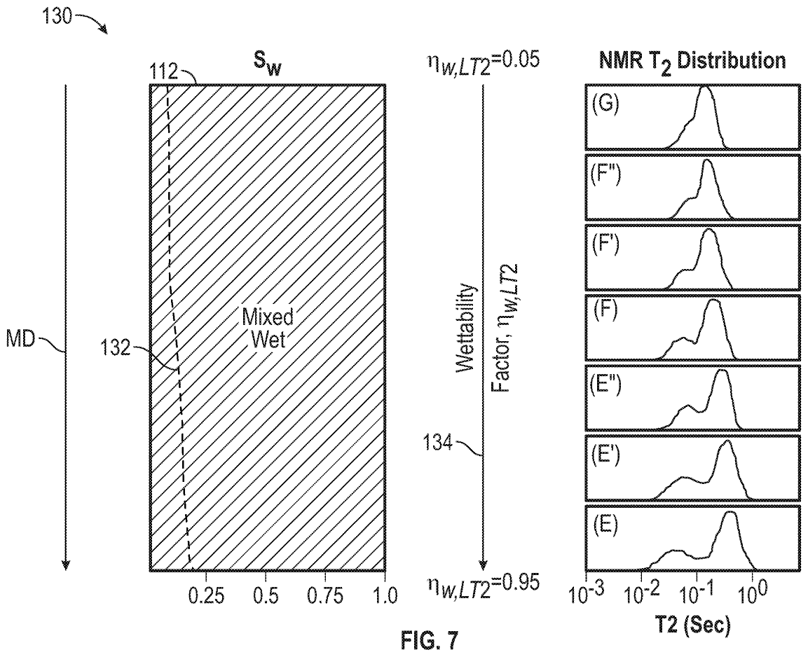

After the data processing system 38 has determined and/or refined the formation-specific parameters T_{c} and α at block 78 and block 80, and the NMR-based logging tool has left the transition zone of the formation, the data processing system 38 may begin receiving logging data indicative of T₂ relaxation times within the mixed-wet zone of the formation from the NMR-based logging tool at block 82. The logging data (e.g., T₂ relaxation times) may be consolidated into T₂ distributions by the data processing system 38, and the T₂ distributions may include one or more peaks corresponding to hydrocarbons and water within the mixed-wet zone of the formation. As the NMR-based logging tool moves through the borehole, the water saturation S_{w} of the formation may vary (e.g., decrease). In some embodiments, the water saturation S_{w} within the mixed-wet zone of the formation may generally take values in accordance with S_{w}≤0.3. As the water saturation S_{w} varies with depth (e.g., decreases from approximately 0.3 as the NMR-based logging tool ascends through the mixed-wet zone of the formation), the hydrocarbon and water T₂ peaks may move relative to each other based on the change in water saturation S_{w}. For instance, the hydrocarbon and water T₂ peaks may move towards each other as the water saturation S_{w} decreases. Within the mixed-wet zone, the water-wetting surface fraction η_{w,LT}_{₂} may also vary (e.g., decrease) between 0 and approximately 1. This variation in the value of η_{w,LT}_{₂} may be correlated to the relative movements of the hydrocarbon and water T₂ peaks, as can be seen in FIG. 7.

Thus, a machine learning model may be trained to determine a change in the value of the water-wetting surface fraction η_{w,LT}_{₂} corresponding to the relative movement of the hydrocarbon and water T₂ peaks (e.g., as water saturation S_{w} decreases). At block 104, this machine learning model may determine a change in the value of the water-wetting surface fraction η_{w,LT}_{₂} based on the relative movement of the hydrocarbon and water T₂ peaks; because η_{w,LT}_{₂} may be assumed to be approximately equal to 1 within the transition zone, the machine learning model may provide at block 104 an estimated value of η_{w,LT}_{₂} by depth within the mixed-wet zone by implementing each determined change (e.g., subtracting the initial change to η_{w,LT}_{₂} from 1 and, as water saturation S_{w} decreases with decreasing depth, continuing to subtract each change from the estimated value corresponding to the preceding depth). In some embodiments, the machine learning model may be trained to determine the value of the water-wetting surface fraction η_{w,LT}_{₂} directly, based on the relative position of the bulk water and bulk hydrocarbon T₂ peaks. In some embodiments, the data processing system 38 may continuously or iteratively determine η_{w,LT}_{₂} by depth within the formation at block 104.

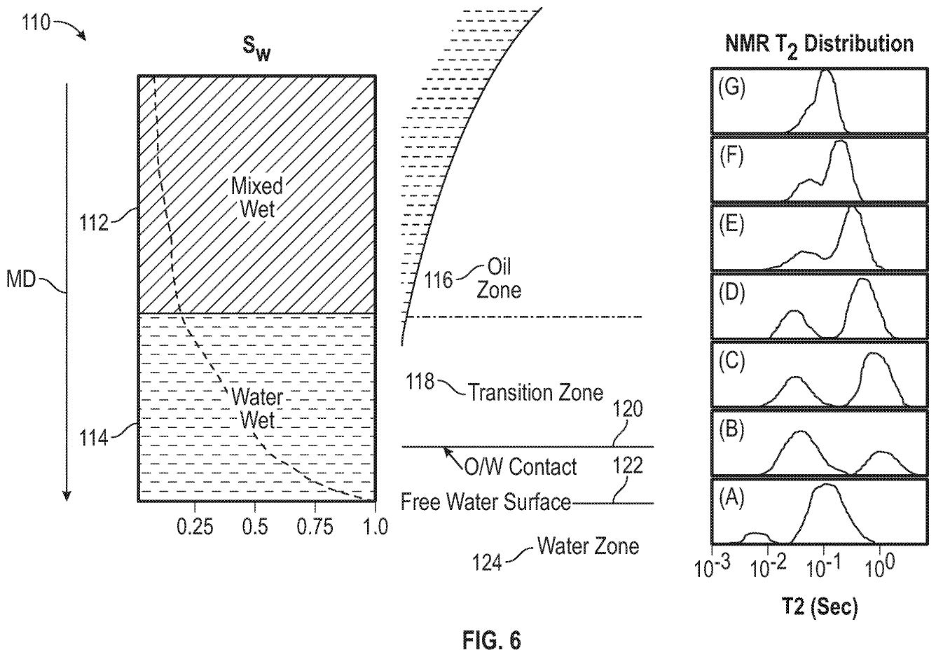

FIG. 6 depicts a chart 110 illustrating the shift in T₂ distributions of hydrocarbons and/or water as the NMR-based logging tool traverses through various zones of the formation. As illustrated by chart 110 in FIG. 6, the formation may include a mixed-wet region 112 and a water-wet region 114. The water-wet region 114 may be understood as the zones of the formation within which the water-wetting surface fraction η_{w,LT}_{₂} may be assumed to be approximately equal to 1. The mixed-wet region 112 may correspond to the oil zone 116 of the formation, wherein the water-wetting surface fraction η_{w,LT}_{₂} may take values between approximately 1 and 0. A transition zone 118 may separate the oil zone 116 from the water zone 124. Within the transition zone 118, the water saturation S_{w} may take values between approximately 0.7 and approximately 0.3, while the water-wetting surface fraction η_{w,LT}_{₂} may be assumed to be approximately equal to 1. At the bottom of the transition zone 118 may be an oil/water contact 120 (e.g., a meniscus between nonpolar hydrocarbons and polar water). The free water surface 122 may be lower still, with the water zone 124 below the free water surface 122 and continuing to the bottom of the formation.

As further illustrated by chart 110 of FIG. 6, the T₂ distributions collected by the NMR-based logging tool may vary as the NMR-based logging tool ascends through the formation. In accordance with, for example, the in-situ calibration process 70, the NMR-based logging tool may initially be lowered to the bottom of the formation, within the water zone 124, and logged upwards through the formation. A data processing system 38 may receive data indicative of T₂ distributions within the water zone 124 (e.g., NMR T₂ distribution (A)), which may be used as a reference T₂ distribution within other zones. The NMR-based logging tool may continue to be logged upwards, passing through the oil/water contact 120 into the transition zone 118 (still within the water-wet region 114). At this depth, the data processing system 38 may determine and/or refine the formation-specific parameters T_{c} and α based on the T₂ distributions measured within the transition zone 118 using the T₂ distribution from the water zone 124 as a reference. As can be seen in T₂ distributions (B) and (C), multiple peaks may be identified (e.g., a peak for hydrocarbons and a peak for water); the data processing system 38 may disentangle the T₂ distribution of hydrocarbons from the T₂ distribution of water within the transition zone 118, as described above regarding FIG. 4. That is, the data processing system 38 can use the change in the NMR T₂ distribution to choose (e.g., determine) the bulk hydrocarbon (e.g., bulk oil) signal. This can be transmitted as an input to a reservoir characterization program to allow for changes in production plans.

After determining and/or refining the formation-specific parameters T_{c} and α, the NMR-based logging tool may be logged further upwards into the oil zone 116 and/or the mixed-wet region 112. As the NMR-based logging tool exits the water-wet region 114, the water-wetting surface fraction η_{w,LT}_{₂} may decrease from 1 (up to a minimum value of 0). Within the mixed-wet region 112, the water-wetting surface fraction η_{w,LT}_{₂} may be continuously or iteratively determined by depth in accordance with, for example, block 82 of FIG. 4 and/or block 102 of FIG. 5.

FIG. 7 depicts a chart 130 illustrating the shift in T₂ distributions of hydrocarbons and/or water as the NMR-based logging tool traverses through the mixed-wet region 112 of the formation. By way of example, FIG. 7 may be understood as an expansion of portions of FIG. 6. As depicted in FIG. 7, the water saturation 132 (S_{w}) may decrease from 0.25 within the mixed-wet region 112, while the T₂ distributions may vary according to depth, with the T₂ peaks for hydrocarbons and water moving closer together as the water saturation 132 decreases. The wettability factor 134 (η_{w,LT}_{₂}) may also decrease from approximately 0.95 to approximately 0.05 within the mixed-wet region 112 and may be determined in accordance with block 82 of FIG. 4 and/or block 102 of FIG. 5. For instance, when the wettability factor 134 is determined in accordance with block 102 of FIG. 5, the machine learning model may be trained to determine the wettability factor 134 based on the relative movement of the hydrocarbon and water T₂ peaks, which may be seen in the NMR T₂ distributions (E), (E′), (E″), (F), (F′), (F″), and (G) as depicted in chart 130. In this manner, the chart 130 of FIG. 7 illustrates change in the NMR T₂ distribution that allows for the determination of the bulk hydrocarbon (e.g., bulk oil) signal.

Technical effects of the disclosed embodiments include systems and methods for calibrating NMR-based logging tools and determining various formation-specific parameters corresponding to a geological formation in-situ (e.g., without employing time-consuming, costly, or complex lab procedures). For instance, formation-specific parameters may include the characteristic time that determines the inflection point in the T₂ space T_{c}, the exponent that controls the sharpness of the saturation transition around the characteristic time a, the water-wetting surface fraction η_{w,LT}_{₂}, or any combinations thereof. Furthermore, such formation-specific parameters may be used to determine various characteristics of the geological formation, such as, for example, the wettability of the formation, the relative permeability of the formation, the water-volume fraction of the reservoir corresponding to the geological formation, the pore size of the formation, the fluid-filled porosity, and the like. The formation-specific parameters and/or characteristics of the formation may be used in further modeling of the geological formation and/or the reservoir (e.g., developing simulations of the geological formation and/or the reservoir), as well as for decision-making (e.g., determining whether the accessible hydrocarbons of the reservoir justify constructing a well production system; if yes, determining how large of an investment in a well production system the reservoir justifies; determining whether the well production system should be developed for an oil-wet or a water-wet formation; determining and/or altering a hydrocarbon production schedule corresponding to the reservoir; etc.).

Additionally, the techniques described herein allow for extraction of a T₂ distribution of hydrocarbons (e.g., bulk oil signal or bulk hydrocarbon signal) for an NMR signal in addition to determining how wettability changes as a function of depth. Picking out (determining) the bulk hydrocarbon signal can assist in determining viscosity at the respective depths of the formation. Viscosity can operate as a measurement of the ease of flow of fluids (e.g., hydrocarbons) at a given depth. In this way, extraction of the T₂ distribution of hydrocarbons in conjunction with the techniques described herein provides an indication as to where oil will be produced in a formation (i.e., based upon the viscosity determined from the T₂ distribution of hydrocarbons). This is in addition to picking out (determining) the bulk hydrocarbon signal as it changes as a function of depth as an indication of a wettability change as a function of depth to be provided to a reservoir simulator, for example, to allow for an improved determination of relative permeability of the formation so as to allow for improved production planning, operations, etc.

The subject matter described in detail above may be defined by one or more clauses, as set forth below.

According to a first aspect, a method includes conveying a nuclear magnetic resonance (NMR)-based logging tool through a borehole to a fully-water saturated zone of a geological formation; receiving, from the NMR-based logging tool, first data indicative of a first transverse (T₂) relaxation time corresponding to the fully-water saturated zone to determine a fully-water saturated T₂ distribution; receiving, from the NMR-based logging tool, second data indicative of a second T₂ relaxation time corresponding to a partially saturated water-wet zone of the geological formation; and determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution. The method further includes modeling a predicted second T₂ relaxation time based on the T_{c}, the α, and the fully-water saturated T₂ distribution; and refining the T and the α based on a comparison of the second T₂ relaxation time and the predicted second T₂ relaxation time. Additionally, the method includes receiving, from the NMR-based logging tool, third data indicative of a third T₂ relaxation time corresponding to a mixed-wet zone of the geological formation; modeling a predicted third T₂ relaxation time based on the T_{c}, the α, the fully-water saturated T₂ distribution, and a water saturation (S_{w}); determining a water-wetting surface fraction (η_{w}) corresponding to the mixed-wet zone based on the third T₂ relaxation time, the predicted third T₂ relaxation time, the T_{c}, and the α; and performing a minimization procedure to decrease a difference between the third T₂ relaxation time and the predicted third T₂ relaxation time to refine the water-wetting surface fraction (η_{w}).

The method of the preceding clause, further including determining a wettability of the geological formation based on the T_{c}, the α, and the water-wetting surface fraction (η_{w}).

The method of any preceding clause, further including modeling the geological formation based on the T_{c}, the α, and the water-wetting surface fraction (η_{w}).

The method of any preceding clause, further including determining the water-wetting surface fraction (η_{w}) using a machine learning model.

The method of any preceding clause, further including determining an overall wettability index (I_{w}) based on the water-wetting surface fraction (η_{w}).

The method of any preceding clause, further including separating a T₂ distribution corresponding to hydrocarbons within the geological formation from the second data and the third data.

The method of any preceding clause, wherein the T_{c} and the α are determined assuming a water saturation S_{w} and the water-wetting surface fraction (η_{w}) are equal to 1.

The method of any preceding clause, further including refining the T_{c} and the α by minimizing a difference between the second T₂ relaxation time and the predicted second T₂ relaxation time.

According to a second aspect, a system includes a nuclear magnetic resonance (NMR)-based logging tool configured to collect data indicative of a transverse (T₂) relaxation time within a borehole drilled into a geological formation and a data processing system in communication with the NMR-based logging tool. The data processing system is configured to perform operations including receiving, from the NMR-based logging tool, first data indicative of a first T₂ relaxation time corresponding to a fully-water saturated zone of the geological formation to determine a fully-water saturated T₂ distribution; receiving, from the NMR-based logging tool, second data indicative of a second T₂ relaxation time corresponding to a partially saturated water-wet zone of the geological formation; determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution; modeling a predicted second T₂ relaxation time based on the T_{c}, the α, and the fully-water saturated T₂ distribution; and refining the T_{c} and the α based on a comparison of the second T₂ relaxation time and the predicted second T₂ relaxation time. The data processing system is further configured to perform operations including receiving, from the NMR-based logging tool, third data indicative of a third T₂ relaxation time corresponding to a mixed-wet zone of the geological formation; modeling a predicted third T₂ relaxation time based on the T_{c}, the α, the fully-water saturated T₂ distribution, and a water saturation (S_{w}); determining a water-wetting surface fraction (η_{w}) corresponding to the mixed-wet zone based on the third T₂ relaxation time, the predicted third T₂ relaxation time, the T_{c}, and the α; and performing a minimization procedure to decrease a difference between the third T₂ relaxation time and the predicted third T₂ relaxation time to refine the water-wetting surface fraction (η_{w}).

The system of the preceding clause, wherein the data processing system is configured to determine a wettability of the geological formation based on the T_{c}, the α, and the water-wetting surface fraction (η_{w}).

The system of any preceding clause, wherein the data processing system is configured to model the geological formation based on the T_{c}, the α, and the water-wetting surface fraction (η_{w}).

The system of any preceding clause, wherein the data processing system includes a machine learning model, wherein the data processing system is configured to determine the water-wetting surface fraction (η_{w}) using the machine learning model.

The system of any preceding clause, wherein the data processing system is configured to perform operations further including determining an overall wettability index (I_{w}) based on the water-wetting surface fraction (η_{w}).

The system of any preceding clause, wherein the data processing system is configured to perform operations further including refining the T_{c} and the α by minimizing a difference between the second T₂ relaxation time and the predicted second T₂ relaxation time.

The system of any preceding clause, wherein the data processing system is configured to perform operations further including separating a T₂ distribution corresponding to hydrocarbons within the geological formation from the second data and the third data.

According to a third aspect, a tangible, non-transitory, computer-readable medium includes executable instructions that, when executed by processing circuitry, cause the processing circuitry to perform operations including receiving, from a nuclear magnetic resonance (NMR)-based logging tool, first data indicative of a first transverse (T₂) relaxation time corresponding to a fully-water saturated zone of a geological formation to determine a fully-water saturated T₂ distribution; receiving, from the NMR-based logging tool, second data indicative of a second T₂ relaxation time corresponding to a partially saturated water-wet zone of the geological formation; determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution; modeling a predicted second T₂ relaxation time based on the T_{c}, the α, and the fully-water saturated T₂ distribution;

and refining the T_{c} and the α based on a comparison of the second T₂ relaxation time and the predicted second T₂ relaxation time. The operations further include receiving, from the NMR-based logging tool, third data indicative of a third T₂ relaxation time corresponding to a mixed-wet zone of the geological formation; modeling a predicted third T₂ relaxation time based on the T_{c}, the α, the fully-water saturated T₂ distribution, and a water saturation (S_{w}); determining a water-wetting surface fraction (η_{w}) corresponding to the mixed-wet zone of the geological formation based on the third T₂ relaxation time, the predicted third T₂ relaxation time, the T_{c}, and the α; and performing a minimization procedure to decrease a difference between the third T₂ relaxation time and the predicted third T₂ relaxation time to refine the water-wetting surface fraction (η_{w}).

The tangible, non-transitory, computer-readable medium of the preceding clause, wherein the executable instructions, when executed by the processing circuitry, cause the processing circuitry to perform operations further including determining a wettability of the geological formation based on the T_{c}, the α, and the water-wetting surface fraction (η_{w}).

The tangible, non-transitory, computer-readable medium of any preceding clause, wherein the executable instructions, when executed by the processing circuitry, cause the processing circuitry to perform operations further including modeling the geological formation based on the T_{c}, the α, and the water-wetting surface fraction (η_{w}).

The tangible, non-transitory, computer-readable medium of any preceding clause, wherein the executable instructions, when executed by the processing circuitry, cause the processing circuitry to perform operations further including determining the water-wetting surface fraction (η_{w}) using a machine learning model.

The tangible, non-transitory, computer-readable medium of any preceding clause, wherein the executable instructions, when executed by the processing circuitry, cause the processing circuitry to perform operations further including refining the T_{c} and the α by minimizing a difference between the second T₂ relaxation time and the predicted second T₂ relaxation time.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principals of the disclosure and its practical applications, to thereby enable others skilled in the art to best utilize the disclosure and various embodiments with various modifications as are suited to the particular use contemplated.

Finally, the techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
conveying a nuclear magnetic resonance (NMR)-based logging tool through a borehole to a fully-water saturated zone of a geological formation;
receiving, from the NMR-based logging tool, first data indicative of a first transverse (T₂) relaxation time corresponding to the fully-water saturated zone to determine a fully-water saturated T₂ distribution;
receiving, from the NMR-based logging tool, second data indicative of a second T₂ relaxation time corresponding to a partially saturated water-wet zone of the geological formation;
determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution;
modeling a predicted second T₂ relaxation time based on the T_{c}, the α, and the fully-water saturated T₂ distribution;
refining the T_{c} and the α based on a comparison of the second T₂ relaxation time and the predicted second T₂ relaxation time;
receiving, from the NMR-based logging tool, third data indicative of a third T₂ relaxation time corresponding to a mixed-wet zone of the geological formation;
modeling a predicted third T₂ relaxation time based on the T_{c}, the α, the fully-water saturated T₂ distribution, and a water saturation (S_{w});
determining a water-wetting surface fraction (η_{w}) corresponding to the mixed-wet zone based on the third T₂ relaxation time, the predicted third T₂ relaxation time, the T_{c}, and the α; and
performing a minimization procedure to decrease a difference between the third T₂ relaxation time and the predicted third T₂ relaxation time to refine the water-wetting surface fraction (η_{w}).

2. The method of claim 1, further comprising determining a wettability of the geological formation based on the T_{c}, the α, and the water-wetting surface fraction (η_{w}).

3. The method of claim 1, further comprising modeling the geological formation based on the T_{c}, the α, and the water-wetting surface fraction (η_{w}).

4. The method of claim 1, comprising determining the water-wetting surface fraction (η_{w}) using a machine learning model.

5. The method of claim 1, further comprising determining an overall wettability index (I_{w}) based on the water-wetting surface fraction (η_{w}).

6. The method of claim 1, further comprising separating a T₂ distribution corresponding to hydrocarbons within the geological formation from the second data and the third data.

7. The method of claim 1, wherein the T_{c} and the α are determined assuming a water saturation S_{w} and the water-wetting surface fraction (η_{w}) are equal to 1.

8. The method of claim 1, comprising refining the T_{c} and the α by minimizing a difference between the second T₂ relaxation time and the predicted second T₂ relaxation time.

9. A system comprising:
a nuclear magnetic resonance (NMR)-based logging tool configured to collect data indicative of a transverse (T₂) relaxation time within a borehole drilled into a geological formation; and
a data processing system in communication with the NMR-based logging tool, wherein the data processing system is configured to perform operations comprising:
receiving, from the NMR-based logging tool, first data indicative of a first T₂ relaxation time corresponding to a fully-water saturated zone of the geological formation to determine a fully-water saturated T₂ distribution;
receiving, from the NMR-based logging tool, second data indicative of a second T₂ relaxation time corresponding to a partially saturated water-wet zone of the geological formation;
determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution;
modeling a predicted second T₂ relaxation time based on the T_{c}, the α, and the fully-water saturated T₂ distribution;
refining the T_{c} and the α based on a comparison of the second T₂ relaxation time and the predicted second T₂ relaxation time;
receiving, from the NMR-based logging tool, third data indicative of a third T₂ relaxation time corresponding to a mixed-wet zone of the geological formation;
modeling a predicted third T₂ relaxation time based on the T_{c}, the α, the fully-water saturated T₂ distribution, and a water saturation (S_{w});
determining a water-wetting surface fraction (η_{w}) corresponding to the mixed-wet zone based on the third T₂ relaxation time, the predicted third T₂ relaxation time, the T_{c}, and the α; and
performing a minimization procedure to decrease a difference between the third T₂ relaxation time and the predicted third T₂ relaxation time to refine the water-wetting surface fraction (η_{w}).

10. The system of claim 9, wherein the data processing system is configured to determine a wettability of the geological formation based on the T_{c}, the α, and the water-wetting surface fraction (η_{w}).

11. The system of claim 9, wherein the data processing system is configured to model the geological formation based on the T_{c}, the α, and the water-wetting surface fraction (η_{w}).

12. The system of claim 9, wherein the data processing system comprises a machine learning model, wherein the data processing system is configured to determine the water-wetting surface fraction (η_{w}) using the machine learning model.

13. The system of claim 9, wherein the data processing system is configured to perform operations comprising determining an overall wettability index (I_{w}) based on the water-wetting surface fraction (η_{w}).

14. The system of claim 9, wherein the data processing system is configured to perform operations comprising refining the T_{c} and the α by minimizing a difference between the second T₂ relaxation time and the predicted second T₂ relaxation time.

15. The system of claim 9, wherein the data processing system is configured to perform operations comprising separating a T₂ distribution corresponding to hydrocarbons within the geological formation from the second data and the third data.

16. A tangible, non-transitory, computer-readable medium comprising executable instructions that, when executed by processing circuitry, cause the processing circuitry to perform operations comprising:
receiving, from a nuclear magnetic resonance (NMR)-based logging tool, first data indicative of a first transverse (T₂) relaxation time corresponding to a fully-water saturated zone of a geological formation to determine a fully-water saturated T₂ distribution;
receiving, from the NMR-based logging tool, second data indicative of a second T₂ relaxation time corresponding to a partially saturated water-wet zone of the geological formation;
determining a characteristic time (T_{c}) and an exponent value (α) that controls a sharpness of a transition from first sized pores of the fully-water saturated zone to second sized pores of a predetermined water saturation level based on the second T₂ relaxation time and the fully-water saturated T₂ distribution;
modeling a predicted second T₂ relaxation time based on the T_{c}, the α, and the fully-water saturated T₂ distribution;
refining the T_{c} and the α based on a comparison of the second T₂ relaxation time and the predicted second T₂ relaxation time;
receiving, from the NMR-based logging tool, third data indicative of a third T₂ relaxation time corresponding to a mixed-wet zone of the geological formation;
modeling a predicted third T₂ relaxation time based on the T_{c}, the α, the fully-water saturated T₂ distribution, and a water saturation (S_{w});
determining a water-wetting surface fraction (η_{w}) corresponding to the mixed-wet zone of the geological formation based on the third T₂ relaxation time, the predicted third T₂ relaxation time, the T_{c}, and the α; and
performing a minimization procedure to decrease a difference between the third T₂ relaxation time and the predicted third T₂ relaxation time to refine the water-wetting surface fraction (η_{w}).

17. The tangible, non-transitory, computer-readable medium of claim 16, wherein the executable instructions, when executed by the processing circuitry, cause the processing circuitry to perform operations comprising determining a wettability of the geological formation based on the T_{c}, the α, and the water-wetting surface fraction (η_{w}).

18. The tangible, non-transitory, computer-readable medium of claim 16, wherein the executable instructions, when executed by the processing circuitry, cause the processing circuitry to perform operations comprising modeling the geological formation based on the T_{c}, the α, and the water-wetting surface fraction (η_{w}).

19. The tangible, non-transitory, computer-readable medium of claim 16, wherein the executable instructions, when executed by the processing circuitry, cause the processing circuitry to perform operations comprising determining the water-wetting surface fraction (η_{w}) using a machine learning model.

20. The tangible, non-transitory, computer-readable medium of claim 16, wherein the executable instructions, when executed by the processing circuitry, cause the processing circuitry to perform operations comprising refining the T_{c} and the α by minimizing a difference between the second T₂ relaxation time and the predicted second T₂ relaxation time.
